(19) United States
(12) Patent Application Publication
(10) Pub. No.: US 2015/0207907 A1
(43) Pub. Date: Jul. 23, 2015

(54) HOUSING

(71) Applicant: Esselte Leitz GmbH & Co KG, Stuttgart (DE)

(72) Inventors: Matthias Eisele, Leonberg (DE); Steffen Seiffarth, Filderstadt (DE)

(73) Assignee: Esselte Leitz GmbH & Co KG, Stuttgart (DE)

(21) Appl. No.: 14/420,444

(22) PCT Filed: Jul. 16, 2013
(86) PCT No.: PCT/EP2013/064972

§ 371 Date: Feb. 9, 2015

(30) Foreign Application Priority Data
Aug. 10, 2012 (DE) 10 2012 015 798.3

(51) Int. Cl. H04M 1/02; H04B 1/3888

(52) U.S. Cl. CPC H04M 1/0214; H04M 1/0266; H04B 1/3888

(57) ABSTRACT

The invention relates to a housing (10) for a device that has a touch screen (14), particularly for a tablet PC (12) or a smartphone, comprising a receiving portion (16) that has a receiving contour (18) which is adapted to the outer contour of the device (12) and into which said device (12) can be inserted such that it fits exactly, with the touch screen (14) facing an upper side (20) of said receiving portion (16); and comprising a cover (24) that is connected to said receiving portion (16) by means of at least one hinge (22), and that can be pivoted from a closed position in which it covers the upper side (20) of the receiving portion (16), into an open position in which it is lifted from the upper side (20) of the receiving portion (16) thus exposing the touch screen (14). Said cover (24) comprises a transparent covering element (30) in the form of a film or a thin pane that is arranged relative to the receiving contour (18) in such a manner that, when in the closed position, it is held flat against the touch screen (14) of the device (12) located in said receiving contour (18).

The invention relates to a housing for a device having a touch screen, particularly for a tablet computer or for a smartphone.

Electronic communication and data processing devices, such as, for example, mobile telephones or tablet computers, are increasingly being equipped with touch screens that are simple to operate. Because of their small dimensions and low weight, such devices easily can be taken along when traveling, and they can be used in practically any desired location, such as in train compartments, in a waiting room or in a restaurant. When using such devices in public, however, the danger exists that unauthorized persons can look at the touch screen from the side and possibly read confidential information. In order to prevent this, privacy filters have been developed, which have the form of a flat pane or a film, and are provided with integrated dark louvers that limit the visibility of the touch screen to a predetermined angle about the incidence plumb line. If one looks at the touch screen from a perpendicular direction, the louvers bring about only a slight impairment of image quality. The more the viewing angle deviates from the incidence plumb line, however, the more the visibility of the touch screen is restricted, until it is invisible to the viewer starting from a specific angle. In this connection, the possibility exists of arranging the louvers only in a lattice structure, so that visibility of the touch screen is restricted from both sides, or of arranging the louvers in a raster structure, so that restriction of the visibility of the touch screen exists from all four viewing directions. Such privacy filters are adhesively attached to the touch screen, for example the film sold by the 3M company under the trade name “VIKUITI,” so that they lie against it over its entire area, in order not to impair the operating ability of the touch screen. Furthermore, the sensitive touch screen can be scratched, or it reflects light in undesirable manner, something that is prevented by adhesively attaching a preferably scratch-resistant protective film or a matte anti-reflective film. Once such a film has been adhesively attached, it is true that it can be pulled off again, without leaving any residue, to a great extent, but then it becomes unusable for renewed use. Therefore the privacy filter or the matte anti-reflection film, for example, remains on the touch screen constantly and restricts its brilliance even when it does not need to be protected from viewing by outsiders or if no disruptive light reflections are expected.

It is therefore the task of the invention to create a possibility for being able to use a covering element that covers the touch screen in more flexible manner.

This task is accomplished, according to the invention, by means of a housing having the characteristics of claim 1.

Advantageous further developments of the invention are the object of the dependent claims.

The invention is based on the idea of disposing the device in question, particularly a tablet computer, in the housing so that the covering element, which has a privacy filter, for example, can be flipped onto the touch screen or removed from it in simple manner, by means of the lid. When the covering element is not needed, for example if there are no fears that unauthorized persons will read confidential information from the touch screen, the lid can be flipped up, so that the full brilliance of the display of the touch screen is available to the user. When the device is used in public, then the lid can be flipped shut with a simple hand motion, so that the privacy filter lies on the touch screen. In this connection, it is preferred that the receiving contour, measured from the top side of the receiving part, has a depth that corresponds to the thickness of the device to be accommodated or is slightly smaller. By means of this measure, it is ensured, to a great extent, that the covering element lies against the touch screen over its full area, so that the latter can be operated without restrictions. In place of the privacy filter or in addition, the covering element can have a matte anti-reflection film, a preferably scratch-resistant protective film or a film with a decorative design. A configuration as a composite material composed of several of the aforementioned types of films or panes is also possible.

The covering element can be directly articulated onto the receiving part and therefore form the lid by itself. However, it is preferred that the lid has a frame articulated onto the receiving part, which frame carries the covering element. The frame imparts increased stability to the covering element, which is generally present as a thin film. It is practical if the frame has a circumferential edge that frames a viewing window and against the inside of which, facing the receiving part, the covering element is disposed to lie. The covering element can be adhesively attached to the circumferential edge or can be attached to the frame using mechanical means. According to an advantageous further development, the circumferential edge has a width that essentially corresponds to the width of a device edge that frames the touch screen of the device to be accommodated. Therefore the full width of the device edge, which the user does not need to be able to view, is utilized in order to impart great stability to the lid.

It is advantageous if the lid has attachment means for releasable attachment to the receiving part at a distance from the at least one hinge. According to a first embodiment, these attachment means can have at least one ferromagnetic element that exerts an attraction force on a further ferromagnetic element on the receiving part in the closed position. For example, a ferromagnet can be disposed in the receiving part, which magnet exerts a magnetic attraction force on a piece of soft iron on the lid, which force must be overcome in order to open the lid. The lid can furthermore consist of spring steel, in whole or in part. It can then be structured to be very thin but nevertheless stable, and is furthermore ferromagnetic, so that no additional piece of soft iron is required.

According to an alternative embodiment, the attachment means are of a mechanical nature and are configured on the receiving part with further mechanical attachment means. These can be engagement connections, hook-and-loop connections, hooks or the like. The attachment means make it possible to connect the lid with the receiving part, in the closed position, so firmly that unintentional flipping open is prevented, to the greatest possible extent.

It is practical if the at least one hinge has a connection part that can pivot about a first pivot axis with reference to the lid and about a second pivot axis with reference to the receiving part. It is advantageous if the connection part has a central access opening that is framed on at least three sides. This has the advantage that the turn-on button of a Samsung tablet computer, which is disposed in this region, can be activated by means of reaching through the access opening. Furthermore, it is preferred that the connection part has a base body composed of plastic as well as two reinforcement plates composed of metal disposed on two outer surfaces of the base body that face away from one another, through which the first and the second pivot axis run. The reinforcement plates reinforce the connection part precisely at the locations that are subject to elevated mechanical stress.

It is advantageous if the distance between the first and the second pivot axis corresponds essentially to the thickness of the housing. This measure allows flipping the lid from the top side of the receiving part to an underside of the receiving part that faces away from the top side. In the open position, the lid can thereby be positioned to lie against the underside and is not in the way during handling of the device accommodated in the housing and does not require additional space.

In the following, the invention will be explained in greater detail using an exemplary embodiment schematically represented in the drawing. This shows:

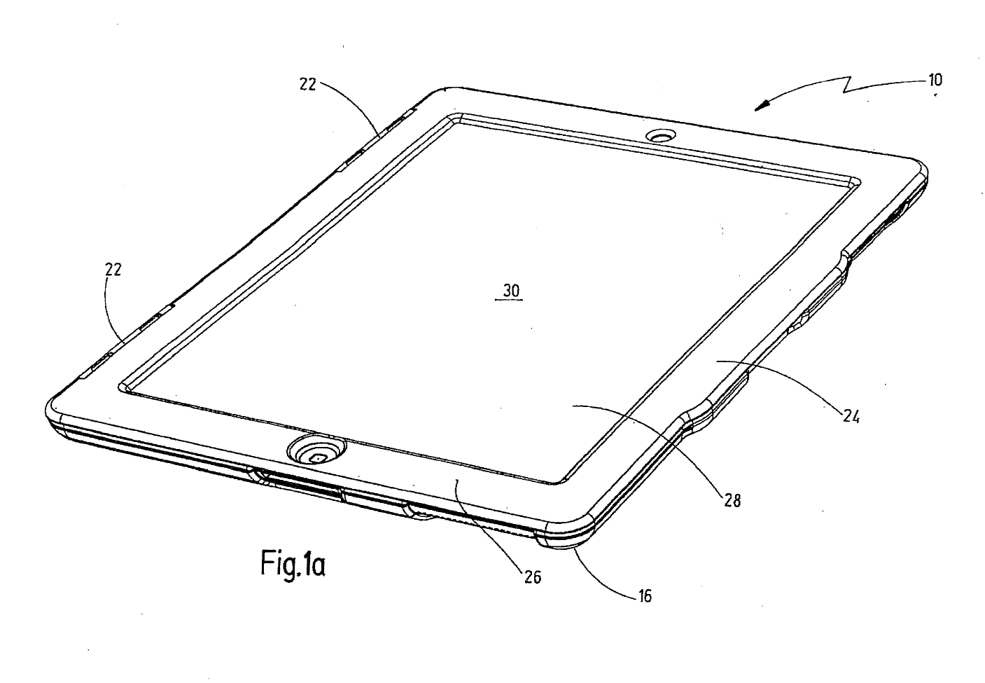

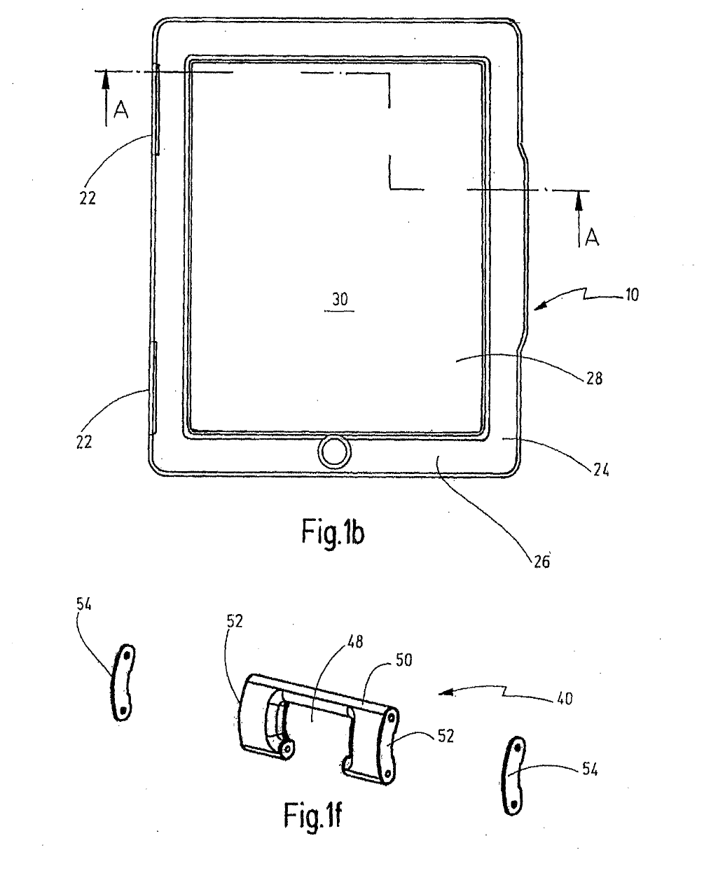

FIG. 1a to 1e a housing with a tablet computer accommodated in it, in the closed position, in a perspective view, in a top view, in a section along the line A-A, in a detail representation according to Detail X, and in a detail representation according to Detail Y, as well as an exploded representation of a connection part of a hinge;

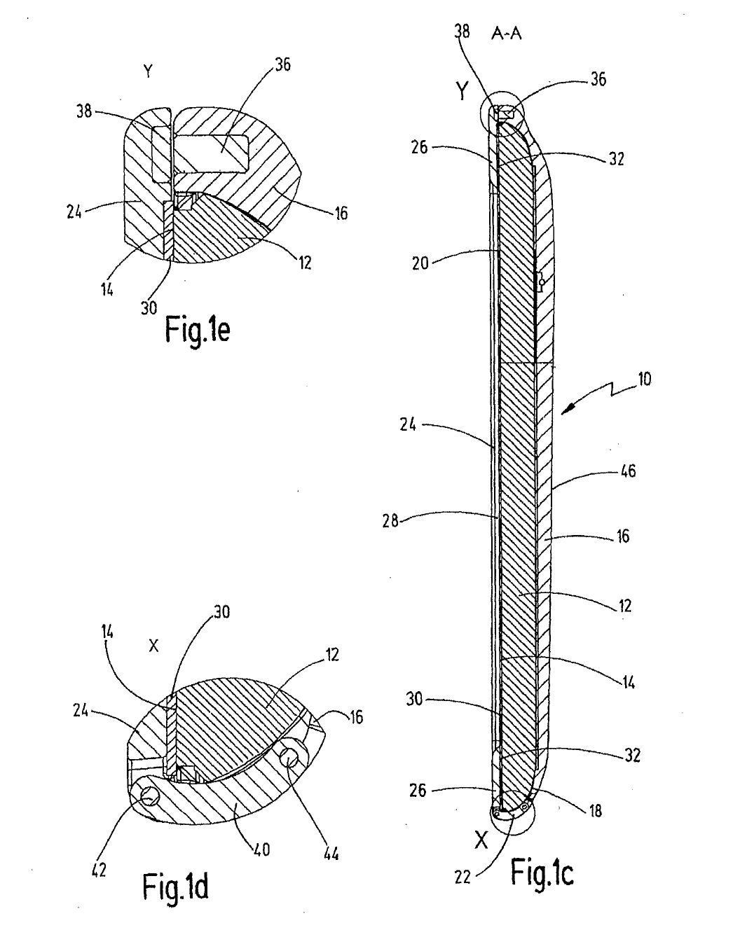

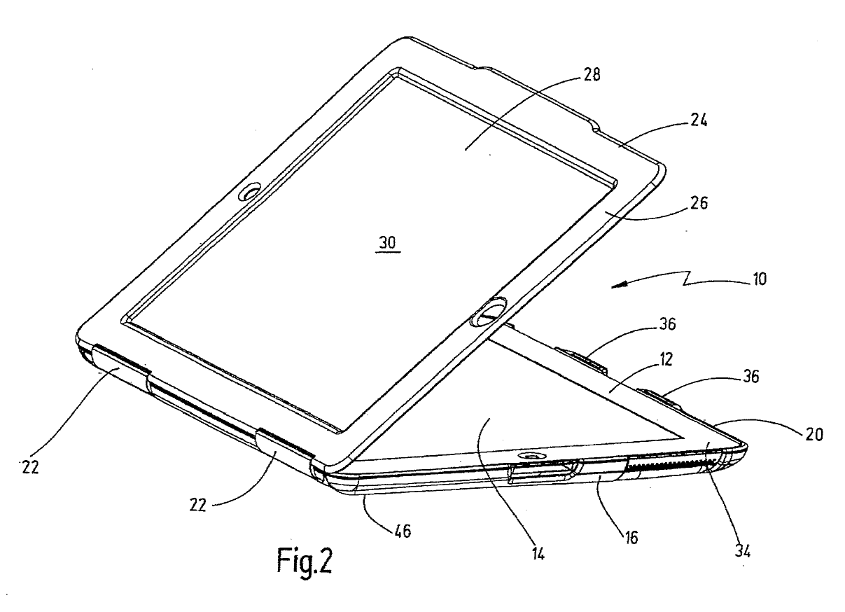

FIG. 2 the housing with the tablet computer accommodated in it, according to FIG. 1a to 1e, in a partly flipped-open state, in a perspective view;

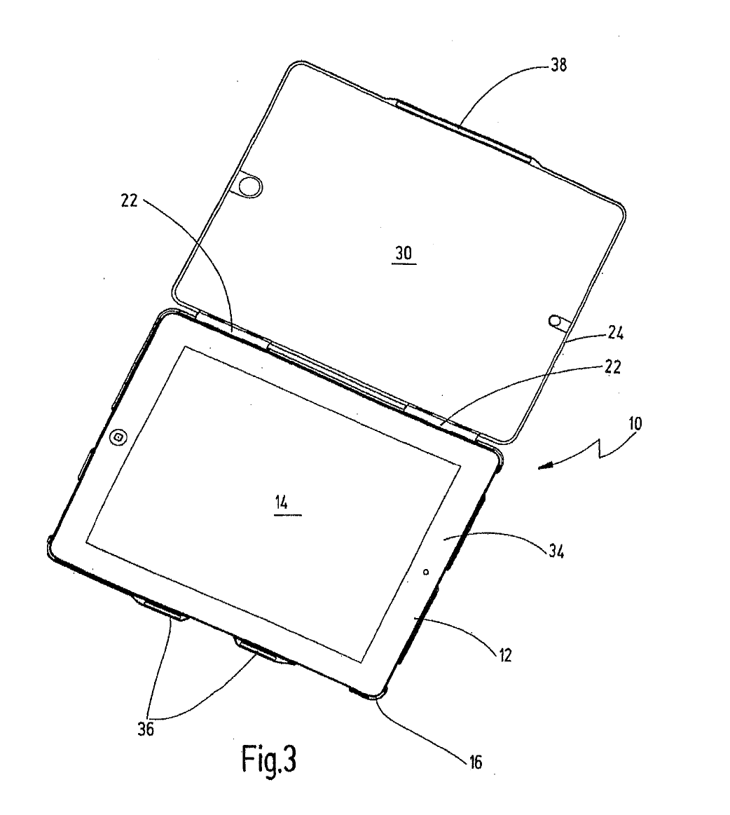

FIG. 3 the housing with the tablet computer accommodated in it, according to FIG. 1a to 1e and FIG. 2, in the completely flipped-open state, and

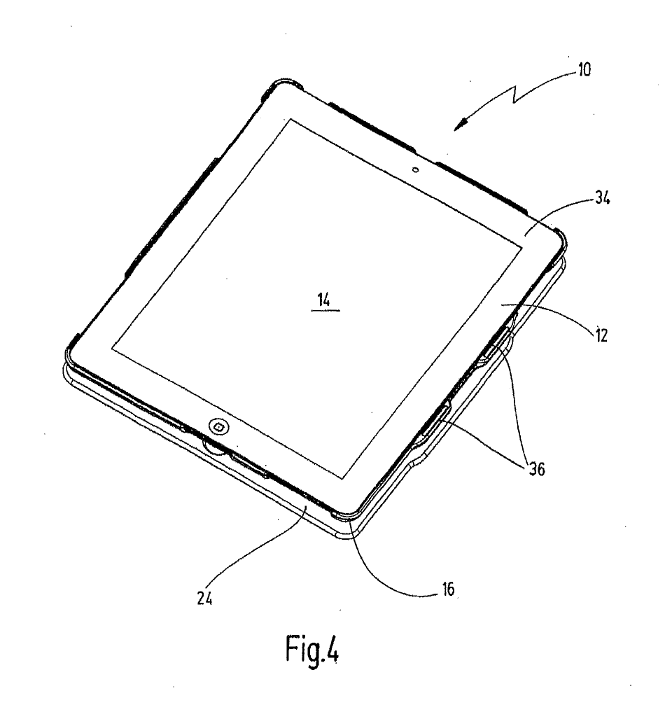

FIG. 4 the housing with the tablet computer accommodated in it, according to FIG. 1a to 1e, FIG. 2, and FIG. 3, with the lid pivoted by 360°.

In the drawing, a housing 10 is shown, which accommodates a tablet computer 12 that has a touch screen 14. The housing 10 has a receiving part 16 that is configured in tub shape and has a receiving contour 18 that is adapted to the outer contour of the tablet computer 12, so that the latter is accommodated in the receiving part 16 with precise fit, with only little play. Toward a top side 20, the receiving part 16 is open. At the receiving part 16, a lid 24 is articulated on by means of two hinges 22, which lid has a frame 26 that is produced from the same non-transparent plastic material as the receiving part 16. The frame 26 forms a circumferential edge and frames a viewing window 28 that exposes a view of the touch screen 14 in the closed position shown in FIG. 1a to 1e. Furthermore, the lid 24 has a privacy filter 30 in the form of a film, which is firmly attached to the frame 26 by means of an adhesive connection, on the inner surface 32 of the frame 26 that faces the receiving part 16. The privacy filter 30 can furthermore be adhesively covered with a matte anti-reflection film, a scratch-resistant protective film or a film carrying a decorative design, in the viewing window 28 and/or on the side facing the touch screen 14.

In the closed position, in which the lid 24 covers the top side 20 of the receiving part 16, the frame 26 is disposed above a device edge 34 of the tablet computer 12, which edge surrounds the touch screen 14. Two permanent magnets 36 are disposed in the receiving part 16, lying opposite the hinges 22, and a piece of soft iron 38 or another ferromagnetic material is disposed on the lid 24, whereby the piece of soft iron 38 is attached by the permanent magnets 36 in the closed position. This magnetic attraction force prevents unintentional opening by means of lifting the lid 24 from the receiving part 16. In the closed position, the privacy filter is held to lie against the touch screen 14. This is achieved in that the receiving contour 18 has a depth, proceeding from the top side 20, that approximately corresponds to the thickness of the tablet computer 12, so that the latter, with its touch screen 14, projects upward all the way to the privacy filter 30 when the housing 10 is in the closed position. The touch screen 14 can then be operated without restrictions by touching the privacy filter 30, but cannot be viewed from the side, starting from a viewing angle of approximately 30° with reference to the plumb line on the privacy filter 30.

If the privacy filter 30 is not needed, the housing 10 is brought into its open position by means of pivoting the lid 24 relative to the receiving part 16 (cf. FIG. 2, 3). In order to be able to pivot the lid 24 onto an underside outer surface 46 of the receiving part 16, facing away from the top side 20, which is not shown in the drawing, the hinges 22 each have a connection part 40 that can be pivoted about a first pivot axis 42 with reference to the lid 24 and about a second pivot axis 44 with reference to the receiving part 16. In this connection, the distance between the first and the second pivot axis 42, 44 approximately corresponds to the thickness of the housing 10. In the exemplary embodiment shown, each connection part 40 has a base body 50 produced in one piece from plastic, which body surrounds an access opening 48 on three sides. Reinforcement plates 54 composed of metal are attached to face-side outer surfaces 52 of the base body 50 that face away from one another, through which plates the pivot axes 42, 44 run, and which plates increase the stability and the wear resistance of the connection part 40.

In summary, the following should be stated: The invention relates to a housing 10 for a device having a touch screen 14, particularly for a tablet computer 12 or for a smartphone, having a receiving part 16 that has a receiving contour 18 adapted to the outer contour of the device 12, into which the device 12 can be set with precise fit, with the touch screen 14 facing a top side 20 of the receiving part 16, and having a lid 24 that is connected with the receiving part 16 by means of at least one hinge 22 and can be pivoted from a closed position, in which it covers the top side 20 of the receiving part 16, into an open position in which it is lifted off from the top side 20 of the receiving part 16, exposing the touch screen 14, wherein the lid 24 has a transparent covering element 30 in the form of a film or a thin pane, which is disposed, in the closed position, in such a manner relative to the receiving contour 18 that it is held to lie against the touch screen 14 of the device 12 situated in the receiving contour 18 over its full area.

1. Housing for a device having a touch screen (14), particularly for a tablet computer (12) or for a smartphone, having a receiving part (16) that has a receiving contour (18) adapted to the outer contour of the device (12), into which the device (12) can be set with precise fit, with the touch screen (14) facing a top side (20) of the receiving part (16), and having a lid (24) that is connected with the receiving part (16) by means of at least one hinge (22) and can be pivoted from a closed position, in which it covers the top side (20) of the receiving part (16), into an open position in which it is lifted off from the top side (20) of the receiving part (16), exposing the touch screen (14), wherein the lid (24) has a transparent covering element (30) in the form of a film or a thin pane, which is disposed, in the closed position, in such a manner relative to the receiving contour (18) that it is held to lie against the touch screen (14) of the device (12) situated in the receiving contour (18) over its full area.

2. Housing according to claim 1, characterized in that the covering element (30) has a privacy filter and reduces the visibility of the touch screen (14) to a predetermined angle range with reference to the plumb line, by means of this filter, in the closed position.

3. Housing according to claim 1 or 2, characterized in that the covering element (30) has an anti-reflection film and/or a protective film for protecting the touch screen (14) against mechanical influences.

4. Housing according to one of the preceding claims, characterized in that the lid (24) has a frame (26) articulated onto the receiving part (16), which frame carries the covering element (30).

5. Housing according to claim 4, characterized in that the frame (26) has a circumferential edge that frames a viewing window (28), and against the inside surface (32) of which frame, facing the receiving part (16), the covering element (30) is disposed to lie.

6. Housing according to claim 5, characterized in that the circumferential edge has a width that essentially corresponds to the width of a device edge (34) that frames the touch screen (14) of the device (12) to be accommodated.

7. Housing according to one of the preceding claims, characterized in that the lid (24) has attachment means (38) for releasable attachment to the receiving part (16), at a distance from the at least one hinge (22).

8. Housing according to claim 7, characterized in that the attachment means have at least one ferromagnetic element (38) that exerts an attraction force on a further ferromagnetic element (36) on the receiving part (16) in the closed position.

9. Housing according to claim 7, characterized in that the attachment means are mechanical attachment means for connecting with further mechanical attachment means on the receiving part (16).

10. Housing according to one of the preceding claims, characterized in that the lid (24) consists, at least in part, of spring steel.

11. Housing according to one of the preceding claims, characterized in that the at least one hinge (22) has a connection part (40) that can be pivoted about a first pivot axis (42) with reference to the lid (24) and about a second pivot axis (44) with reference to the receiving part (16).

12. Housing according to claim 11, characterized in that the connection part (40) has a central access opening (48) framed on at least three sides.

13. Housing according to claim 11 or 12, characterized in that the connection part (40) has a base body (50) composed of plastic as well as two reinforcement plates (54) disposed on two outer surfaces (52) of the base body (50) that face away from one another, composed of metal, through which the first and the second pivot axis (42, 44) run.

14. Housing according to one of claims 11 to 13, characterized in that the distance between the first and the second pivot axis (42, 44) essentially corresponds to the thickness of the housing (10).

15. Housing according to one of the preceding claims, characterized in that the receiving contour (18) has a depth, measured from the top (20) of the receiving part (16), that corresponds to the thickness of the device (12) to be accommodated or is slightly smaller.
